(19) United States
(12) Patent Application Publication
(10) Pub. No.: US 2005/0216221 A1
(43) Pub. Date: Sep. 29, 2005

(54) Systems and methods for cooling storage devices

(76) Inventors: Paul James Broyles III, Cypress, TX (US); Jeff W. Wolford, Spring, TX (US); Gregory P. Ziarnik, Houston, TX (US); Scott Bernard Marcak, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/812,327

(22) Filed: Mar. 29, 2004

(51) Int. Cl. G01K 1/08

(52) U.S. Cl. 702/132

(57) ABSTRACT

In one embodiment, a system and a method for cooling a storage device pertain to determining the temperature of the storage device and adjusting computer operation so as to reduce the temperature of the storage device if that temperature is deemed to be too high.

### BACKGROUND

Computers, such as personal computers (PCs), typically comprise one or more storage devices that are used to store computer programs and/or various data. For instance, it is common for PCs to comprise a hard drive, a floppy disk drive, and one or two compact disc (CD) drives.

Storage devices such as those noted above generate heat during operation. For example, the motors used to spin storage media during reading and writing create heat energy. Various other components within the computer also generate heat. One example is the processor (e.g., central processing unit (CPU)) that may generate so much heat that a heat sink may be required to dissipate some of that heat to prevent the processor from overheating.

Most computers comprise cooling systems that include one or more fans that are used to cool the various components within the computer. In order to reduce power consumption and noise, fan speed is dynamically regulated so that the fan only spins fast when the temperature of the processor or the ambient air within the computer exceeds predefined threshold temperatures. If, for example, the processor begins to overheat, the fan may be operated at an elevated speed until the processor temperature returns to an acceptable level.

Although computers typically monitor the temperature of the processor or ambient air within the computer and take appropriate steps to cool the computer when those temperatures become too high, computers typically do not specifically monitor the temperature of the storage devices or cool the computer in response to one or more storage devices becoming too hot. Because of that, the temperature of the storage devices may exceed the proper temperature operating range even if the temperature of the processor and/or the air in the computer are within acceptable levels. In the case of storage devices used to store data on removable media (e.g., floppy disk or compact disc) the storage devices are now typically stacked on top of each other in close proximity at the top of the computer box where the temperature within the computer is greatest. Even though the computer fan is intended to cool the storage devices, the forced airflow may not be enough to overcome the conditions in which the mass storage devices work. For instance, floppy and compact disc drives are often housed within cages that tend to insulate the devices from the flowing air.

Various negative results can occur when a storage device overheats. By way of example, data integrity problems may result from writing or reading errors that occur when a storage device overheats. Furthermore, data stored on the storage media of the device can be permanently lost. In some cases, permanent damage may be inflicted upon the device or the storage media that it manipulates. Even when such damage does not completely disable the device, that damage can reduce the longevity of the device.

### SUMMARY OF THE DISCLOSURE

In one embodiment, a system and a method for cooling a storage device pertain to determining the temperature of the storage device and adjusting computer operation so as to reduce the temperature of the storage device if that temperature is deemed to be too high.

In another embodiment, a system and a method for cooling a storage device pertain to periodically measuring the temperature of the storage device with a temperature sensor provided in or on the storage device, and periodically providing temperature data including the measured temperature and temperature operating parameters for the storage device to a basic input/output system (BIOS) so that the BIOS can control operation of the computer in an effort to cool the storage device.

### BRIEF DESCRIPTION OF THE DRAWINGS

The disclosed systems and methods can be better understood with reference to the following drawings. The components in the drawings are not necessarily to scale.

FIG. 1 is a perspective view of an embodiment of a computer that includes storage devices and that specifically monitors the temperatures of those devices.

FIG. 2 is a block diagram of a embodiment of the architecture of the computer shown in FIG. 1.

FIG. 3 is a flow diagram that illustrates an embodiment of a method for cooling a storage device.

FIG. 4 is a flow diagram that illustrates an embodiment of operation of a thermal monitor shown in FIG. 2.

FIG. 5 is a flow diagram that illustrates an embodiment of operation of a device driver shown in FIG. 2.

FIG. 6 is a flow diagram that illustrates an embodiment of operation of a system BIOS shown in FIG. 2.

FIG. 7 is a flow diagram that illustrates a further embodiment of a method for cooling a storage device.

FIG. 8 is a flow diagram that illustrates another embodiment of a method for cooling a storage device.

### DETAILED DESCRIPTION

Disclosed herein are systems and methods for cooling a storage device, such as a hard drive, floppy disk, drive or a compact disc (CD) drive. In some embodiments, a computer monitors the temperature of a storage device using a temperature sensor provided in or on the storage device and regulates computer operation in a manner intended to reduce the temperature of the storage device if that temperature is higher than desired. Examples of such computer operation regulation include increasing cooling system fan speed, reducing processor clock speed, reducing processor voltage, and shutting the computer down.

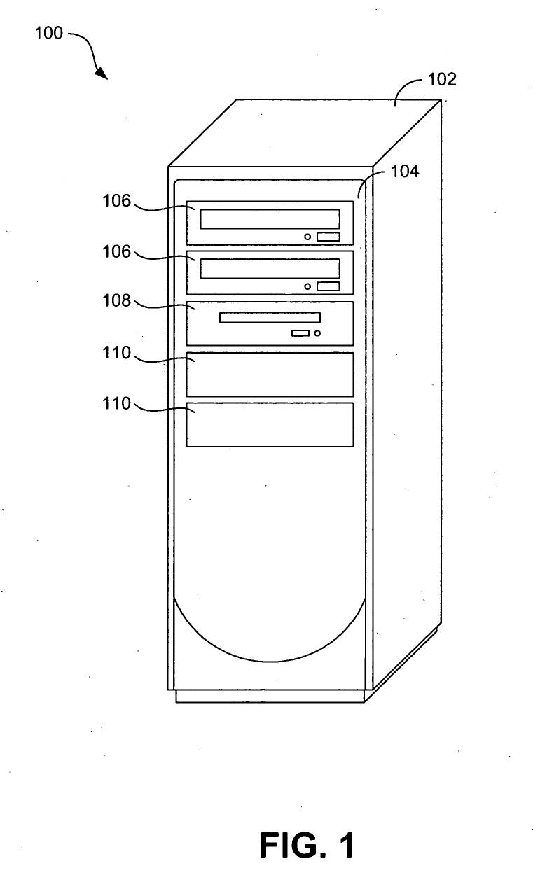

Referring now to the drawings, in which like numerals identify corresponding parts throughout the several views, FIG. 1 illustrates a computer 100, such as a personal computer (PC). The computer 100 generally comprises an outer housing 102 that surrounds an inner chassis (not visible in FIG. 1). At the front of the outer housing 102 is a front panel 104 at which several storage devices that store data on removable media may be accessed. In the example of FIG. 1, those storage devices include two optical drives (e.g., CD drives) 106 and a 3.5. inch floppy drive 108. Although those specific storage devices are illustrated in FIG. 1, the computer 100 can comprise other types of storage devices whose temperature may need to be monitored. For instance, the computer 100 may comprise an internal hard drive (not shown). As is apparent from FIG. 1, the storage devices 106 and 108 are arranged in close proximity to each other in a stacked arrangement. In addition to the storage devices are blank panels 110 that cover cavities in which other storage devices can be installed.

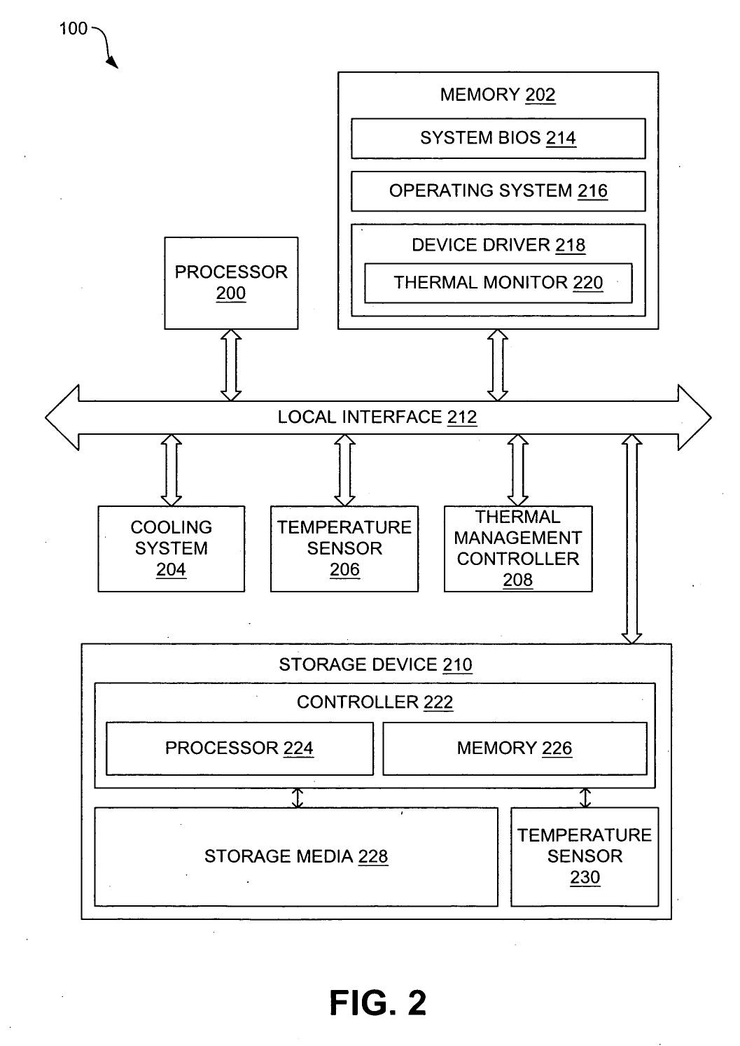

FIG. 2 illustrates an example configuration for the computer 100 of FIG. 1. As indicated in FIG. 2, the computer 100 comprises a processor 200, memory 202, a cooling system 204, a system temperature sensor 206, a thermal management controller 208, and at least one storage device 210 (only one such device illustrated in FIG. 2), each of which is connected to a local interface 212.

The computer processor 200 can include a central processing unit (CPU) or an auxiliary processor among a group of processors associated with the computer 100. The memory 202 includes any one of or a combination of volatile memory elements (e.g., RAM) and nonvolatile memory elements (e.g., read only memory (ROM), flash memory, hard disk, etc.).

The cooling system 204 comprises at least one element that can be used to reduce the temperature of the computer's components. By way of example, the cooling system comprises at least one fan and any elements that are used to direct the flow of air into, throughout, and out from the computer housing 102. When a fan is provided, the fan typically is a variable-speed fan such that the airflow created by the fan can be adjusted.

The temperature sensor 206 is used to measure the temperature of the processor 200, the ambient air within the computer, or both. In the latter case, the temperature sensor 206 may actually comprise two or more individual sensor units that are positioned in appropriate locations within the computer. By way of example, the temperature sensor 206 comprises a thermal diode that indicates temperature by the amount of current that flows through the diode with a given input. Other types of temperature sensors can be used. For instance, the temperature sensor 206 can comprise one or more thermocouples. Although the temperature sensor 206 is normally provided, it is not necessary in all embodiments because, as is described below, the storage device 210 comprises its own temperature sensor.

The thermal management controller 208 comprises logic that is used to regulate the cooling system 204, either in response to data collected using the temperature sensor 206 or in response to another signal provided to the controller. In some embodiments, the thermal management controller 208 comprises an application-specific integrated circuit (ASIC) that includes a plurality of registers whose values affect the manner in which the controller operates the cooling system 204. As is described below, the values within the registers can be changed by the system basic input/output system (BIOS) such that the BIOS can control cooling within the computer 100.

Stored in memory 202 are various programs including a system BIOS 214, an operating system 216, and a device driver 218. The BIOS 214 is normally stored in ROM or flash memory and comprises the logic that maintains control over the low-level operation of the computer components (e.g., storage devices, cooling system, etc.) and any input/output (I/O) devices that are used with the computer (e.g., keyboard, mouse, monitor, etc.). As is discussed below, the BIOS 214 receives temperature data regarding the storage device 210 and, if necessary, modifies computer operation to lower the temperature of that device.

The operating system 216 comprises software that is typically stored in a mass storage device, such as a hard drive, and controls the execution of other software and provides scheduling, input-output control, file and data management, memory management, and communication control and related services. The device driver 218 comprises a program that communicates with the storage device 210 on behalf of the operating system 216 and controls operation of the storage device. In the embodiment of FIG. 2, the device driver 218 encompasses a thermal monitor 220 that is used to collect thermal information about the mass storage device 210 and provide that information to the system BIOS 214 so that the BIOS can determine whether computer operation should be adjusted in view of that information. Although the thermal monitor 220 is illustrated as comprising part of the device driver 218, the thermal monitor can alternatively comprise a separate program that is independent from but can communicate with the device driver 218.

With further reference to FIG. 2, the storage device 210 may comprise any storage device whose temperature is to be monitored. For example, the storage device 210 may be a device that stores data on removable media such as a floppy disk or a CD, such as a floppy drive or an optical drive. In alternative arrangements, the storage device 210 may be the computer's hard drive or may comprise a solid-state storage medium. Regardless, the storage device 210 includes a controller 222, storage media 228 (which may be removable), and a temperature sensor 230. The controller 222 can comprise a single, integrated component (e.g., an ASIC) and/or a plurality of discrete components that together provide a control functionality to the storage device 210. Typically, however, the controller 222 is formed as an integrated semiconductor device that includes a processor 224 and memory 226.

The processor 224 controls operation of the storage device 210 in accordance with boot and operating code stored within memory 226 (e.g., ROM). In addition, the memory 226 comprises logic used to respond to commands or queries for temperature data pertaining to the storage device 210. The processor 200 is configured to receive storage commands from the host system (i.e., operating system 216) and control the delivery of blocks of data to designated storage device addresses of the storage media 228. That media may comprise one or more floppy disks or compact discs, or some form of nonvolatile, solid-state memory (e.g., flash memory, atomic resolution storage memory, and magnetic random access memory (MRAM)).

The temperature sensor 230 is either provided inside or on the storage device 210 and can be similar in configuration to the temperature sensor 206 described above. Accordingly, the temperature sensor 230 may comprise a thermal diode (e.g., integrated into a device circuit board), thermocouple, or other suitable thermal sensor. Regardless, the temperature data measured by the sensor 230 can be read by the controller 222 and therefore provided to an inquiring element (e.g., device driver 218).

Various programs and modules (logic) have been described above. These programs and modules can be stored on any computer-readable medium for use by or in connection with any computer-related system or method. In the context of this disclosure, a computer-readable medium is an electronic, magnetic, optical, or other physical device or means that contains or stores a computer program or module for use by or in connection with a computer-related system or method. Programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

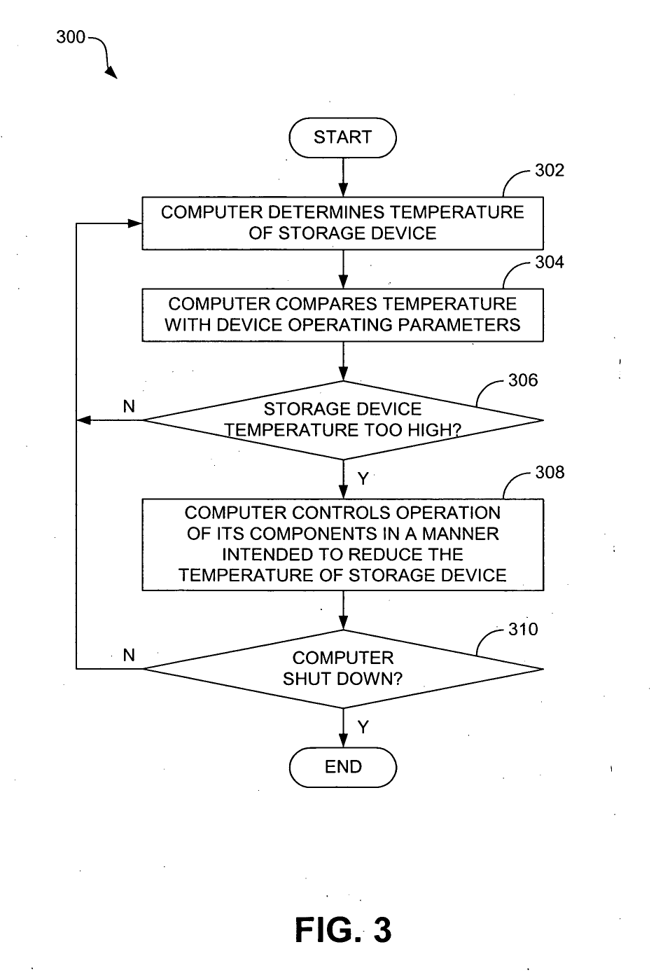

FIG. 3 is a flow diagram 300 that describes a method for cooling a storage device of a computer, such as storage device 210 in FIG. 2. Beginning with block 302 of FIG. 3, the computer determines the temperature of the storage device. In contrast with current systems, the temperature is measured by a temperature sensor (e.g., sensor 230, FIG. 2) of the storage device and not a temperature sensor of the system processor or other sensor. Once the temperature of the storage device has been determined, the computer compares that temperature with the thermal operating parameters of the storage device to, as indicated in block 304, determine whether that temperature is within the proper operating range. By way of example, that operating range may be from approximately 5° C. to 55° C. The thermal operating parameters may already be “known” to the computer (e.g., by the system BIOS) or may have been provided by the storage device controller along with the current device temperature. In either case, the parameter data may describe an ideal temperature operating range, one or more ranges in which the temperature is considered too extreme (either hot or cold), and one or more critical temperatures beyond which the storage device is likely to be unreliable or damaged.

With reference to decision block 306, the computer determines if the storage device temperature is too high. Such a determination may be reached, for example, if the device temperature is above the ideal temperature operating range or approaching the upper limit of that range. If the temperature is not too high, additional cooling measures are not needed and flow returns to block 302 at which the computer again (e.g., on a periodic schedule) determines the temperature of the storage device. If the temperature is determined to be too high, however, flow continues to block 308 at which the computer controls operation of its components in a manner intended to reduce the temperature of the storage device. As mentioned above, such control may effect changes in computer operation in the form of one or more of increasing cooling system fan speed, reducing processor clock speed, reducing processor voltage, and shutting the computer down. These measures are described in greater detail below.

Next, with reference to decision block 310, the computer determines whether the computer is shutting down. That condition may occur in response to the computer determining to shut down due to overheating of the storage device, or simply in response to the user commanding shut down for some other reason. If shut down is occurring or has occurred, flow for the session is terminated. If not, however, flow continues back to block 302 and the process described above is repeated. Therefore, if the temperature of the storage device is still too high (e.g., the same temperature or even higher), other measures can be taken by the computer in a further effort to reduce that temperature.

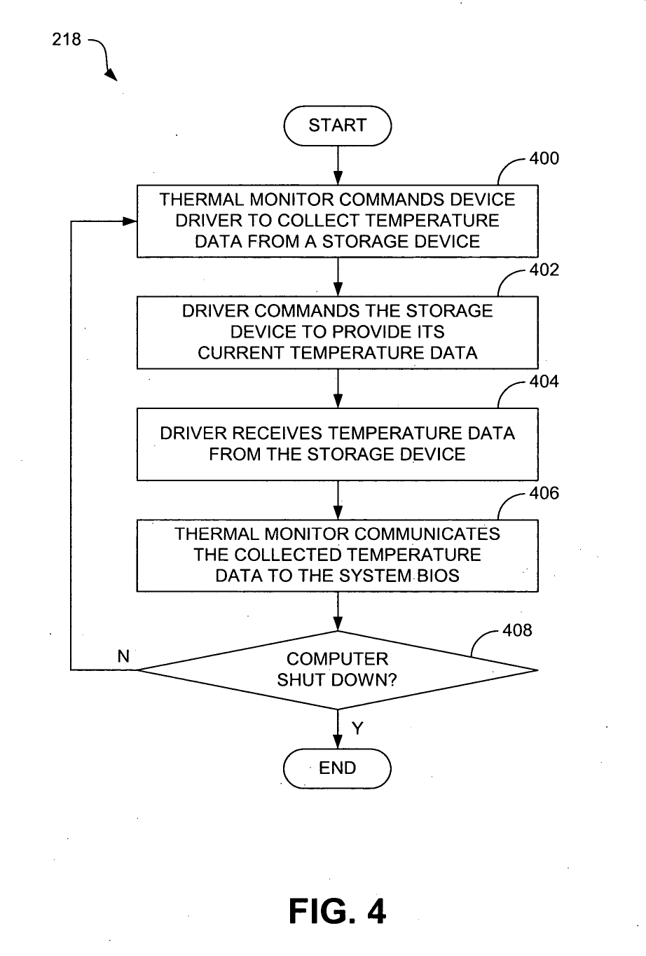

FIG. 4 provides an example of operation of the device driver 218 (and its thermal monitor 220) of the computer 100 in collecting temperature data from a storage device (e.g., storage device 210, FIG. 2). Beginning with block 400, the thermal monitor 220 commands the device driver 218 to collect temperature data from a storage device. The thermal monitor 220 is configured to issue such a command on a regular, periodic basis, for instance every few minutes. By way of example, the command comprises a call from the thermal monitor 220 to an at attachment packet interface (ATAPI) driver to retrieve temperature data from the storage device for which the driver is configured.

Irrespective of the specific nature of the command, the device driver 218 receives the command and, in turn, commands the storage device to provide its current temperature data to the driver, as indicated in block 402. By way of example, that command comprises a self-monitoring, analysis, and reporting technology (SMART) command of the type that is normally used to monitor the operating state of various media drives.

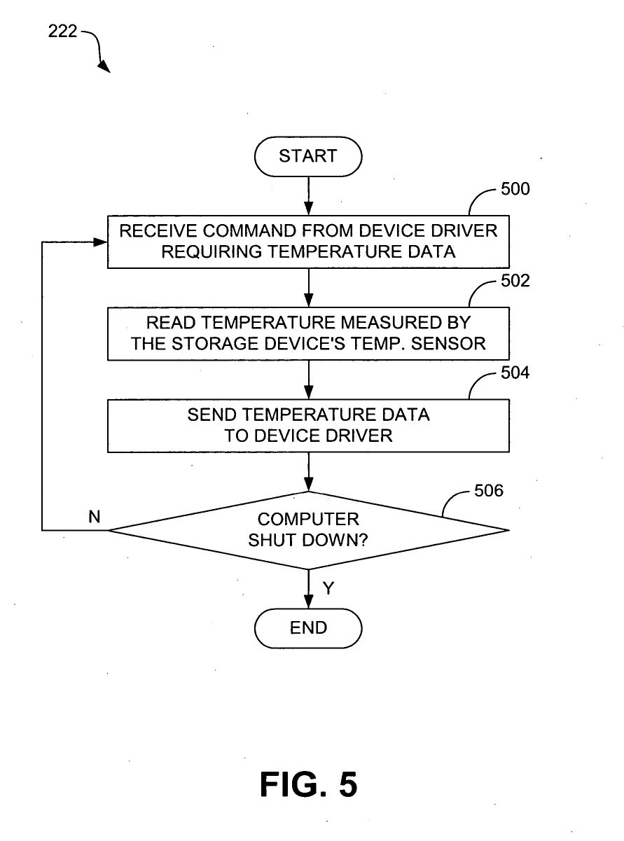

Turning now to FIG. 5, provided is an example of operation of the storage device controller 222 of FIG. 2. Beginning with block 500, the controller 222 receives the command sent by the device driver 218 (block 402 of FIG. 4) requiring temperature data and, as indicated in block 502, reads the temperature measured by the storage device's temperature sensor. As noted above, that temperature sensor may comprise a thermal diode. In such a case, reading the temperature may comprise measuring current flow through the diode and looking up a temperature value associated with the magnitude of that current flow in a table stored in device memory.

Once the temperature data has been read, the storage device controller 222 sends temperature data to the device driver 218, as indicated in block 504, as a response to the command the driver issued to the storage device. The temperature data at least includes the temperature that the controller 222 read in block 502. In addition, however, the temperature data may include information pertaining to the ideal temperature operating range of the storage device, temperature ranges in which operation of the device is not ideal, and one or more critical temperatures beyond which the storage device is likely to be unreliable or damaged (e.g., a peak operating temperature). The provision of such other data by the controller 222 is beneficial given that it is possible that the computer operating system or BIOS may not already have that information, particularly in cases in which the storage device was added after system configuration (e.g., as a replacement or auxiliary device).

Next, with reference to block 506, flow depends upon whether the computer is being shut down. If so, flow for the controller 222 is terminated. If not, flow returns to block 500 at which the controller 222 receives the next (e.g., periodic) command from the device driver 218.

Returning to FIG. 4, the device driver 218 receives the temperature data provided by the storage device, as indicated in block 404. At this point, the thermal monitor 220 communicates the collected temperature data to the system BIOS (e.g., BIOS 214, FIG. 2), as indicated in block 406, to enable the BIOS to control computer operation as necessary to ensure that the storage device does not overheat. Notably, in embodiments in which the thermal monitor 220 is separate and independent from the device driver 218, the driver may first send the temperature data to the thermal monitor 220 in response to the thermal monitor's command to collect that data. By way of example, the thermal monitor 220 communicates the temperature data to the BIOS using an advanced configuration and power interface (ACPI) method that generates a system management interrupt (SMI).

With reference next to decision block 408, flow again depends upon whether the computer is being shut down. If so, flow for the device driver 218 (and its thermal monitor 220) is terminated. If not, however, flow returns to block 400 at which the thermal monitor 220 provides another command (e.g., at the next periodic instance) to the device driver 218 to collect temperature data from the storage device.

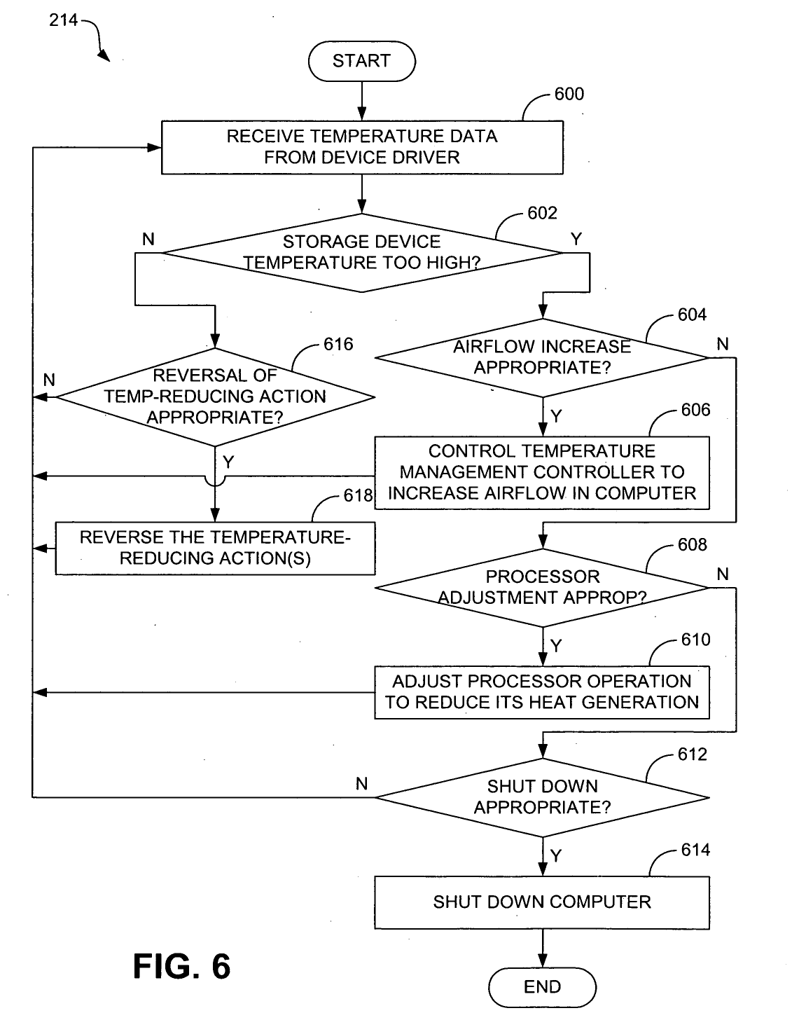

FIG. 6 provides an example of operation of the system BIOS 214. Beginning with block 600, the BIOS receives the temperature data provided by the thermal monitor 220 (block 406 in FIG. 4). From that data, the BIOS 214 can determine if the mass storage device temperature is too high, as is indicated in decision block 602. Again, that determination can be made in view of temperature operating parameters contained in the data. Alternatively, however, if such information was not included in the received data, the BIOS 214 can make a determination as to whether the temperature is too high based upon its own knowledge of the storage device.

If it is determined that the temperature is too high, for instance the temperature is within or above the high end of the ideal operating range, the BIOS 214 determines whether an airflow increase is appropriate, as indicated in block 604. That determination is made in view of the various conditions under which the computer is currently operating. For instance, if the airflow was recently increased (e.g., in a previous monitoring cycle), a further increase may not yet be warranted and such increase may be delayed in order to give the previous increase a chance to lower the storage device temperature. In another case, the airflow may already be at a maximum for the cooling system. For instance, if the fan or fans is/are already operating at the highest possible speed, an airflow increase is not an available option for lowering the temperature of the storage device.

If an airflow increase is not appropriate, flow continues down to decision element 608 described below. If, on the other hand, and airflow increase is appropriate (e.g., the fan is not currently at its highest speed and speed increases have not been recently implemented), the BIOS 214 controls the temperature management controller (e.g., controller 208, FIG. 2) to increase the airflow in the computer (or otherwise increase the cooling capacity of the cooling system 204), as indicated in block 606. The temperature management controller can be controlled to effect such an increase in a variety of different ways. In one scenario, the BIOS 214 adjusts values in registers of the temperature management controller that set the point at which the controller implements a fan speed increase. For example, if the temperature management controller is configured to increase the fan speed when the ambient temperature within the computer exceeds 40° C. (e.g., as measured by temperature sensor 206, FIG. 2), the register values can be adjusted such that the controller will increase the fan speed at a lower temperature, such as 30° C. In such a case, a temperature management controller that is configured to control the cooling system relative to a temperature sensor other than that provided in or on the storage medium can be used to increase the cooling capacity to cool the storage medium. After the BIOS 214 controls the temperature management controller as described above, flow returns to block 600 for the next monitoring cycle.

With reference to decision block 608, if an airflow increase was not appropriate, the BIOS 214 determines whether to adjust the processor operation to reduce its heat generation. Such adjustment may comprise, for example, one or both of reducing the clock speed of the processor (i.e., throttle the processor) or reducing the voltage provided to the processor. Given that computer processors often generate the bulk of the heat within modem computers, either action could significantly reduce heat within the computer and, therefore, the storage devices. If such an adjustment is deemed warranted, flow continues to block 610 at which processor operation is so adjusted. Flow then returns to block 600.

If adjustment of processor operation is not appropriate, for instance a reduction in clock speed or processor voltage would result in unacceptable performance or if such a reduction were already implemented, flow continues to decision block 612 at which the BIOS 214 determines whether to shut down the computer to avoid damage to the storage device. Normally, such a measure is only deemed appropriate in cases in which the temperature of the storage device is near, at, or exceeds the critical temperature. In such a situation, the BIOS 214 may instruct the operating system to present a pop-up warning to the user that identifies the problem and indicates that the computer is going to be shut down. If such shut down is warranted, flow continues to block 614 at which the shut down process is initiated. At this point, flow for the BIOS in a temperature regulation capacity is terminated. If shut down is not warranted, however, flow returns to block 600.

Returning to decision block 602, if the storage device temperature is not too high, for instance if one or more of the measures described above were sufficient to reduce the temperature of the storage device or if no such measures were necessary in the first place, flow continues to decision block 616 at which the BIOS 214 determines whether reversal of a temperature-reducing action is appropriate. Such a reversal may comprise, for example, reducing the speed of a fan and/or increasing the speed or voltage of the processor after the storage device has cooled. In such a case, the BIOS 214 may reverse one or more of the temperature-reducing actions, as indicated in block 618, and flow will return to block 600. If reversal is not appropriate, for example no such measures were taken in the first place, flow returns directly to block 600.

Although not shown in FIG. 6, the BIOS 214 can further store data about the observed storage device temperatures and/or the measures taken to reduce the temperature of the storage device. Such data could, for example, be stored on a device that is separate from the monitored storage device (e.g., the hard drive if an optical drive is/was being monitored). Operating in this manner, the BIOS maintaining a thermal history or log for the storage device that a user or technician can use for diagnostic or design purposes.

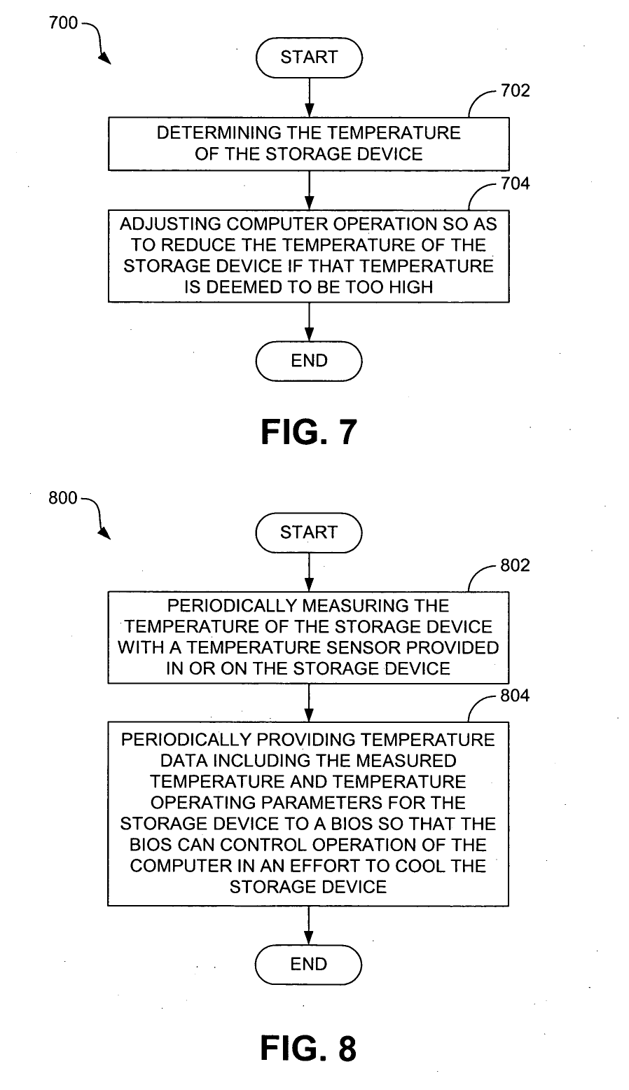

A further method 700 for cooling a storage device is described with reference to FIG. 7. As indicated in that figure, the method 700 comprises determining the temperature of the storage device (block 702) and adjusting computer operation so as to reduce the temperature of the storage device if that temperature is deemed to be too high (block 704).

Another method 800 for cooling a storage device is described with reference to FIG. 8. As indicated in that figure, the method 800 comprises periodically measuring the temperature of the storage device with a temperature sensor provided in or on the storage device (block 802) and periodically providing temperature data including the measured temperature and temperature operating parameters for the storage device to a basic input/output system (BIOS) so that the BIOS can control operation of the computer in an effort to cool the storage device (block 804).

1. A method for cooling a storage device contained in a computer, the method comprising:
determining the temperature of the storage device; and
adjusting computer operation so as to reduce the temperature of the storage device if that temperature is deemed to be too high.

2. The method of claim 1, wherein determining the temperature of the storage device comprises measuring the temperature of the storage device using a temperature sensor provided in or on the storage device.

3. The method of claim 1, wherein measuring the temperature of the storage device comprises measuring the temperature of the storage device using a thermal diode of the storage device.

4. The method of claim 1, wherein adjusting computer operation so as to reduce the temperature of the storage device comprises increasing the speed of a fan contained within the computer.

5. The method of claim 1, wherein adjusting computer operation so as to reduce the temperature of the storage device comprises adjusting the operation of a processor contained within the computer.

6. The method of claim 5, wherein adjusting the operation of a processor comprises reducing the clock speed of the processor.

7. The method of claim 5, wherein adjusting the operation of a processor comprises reducing a voltage provided to the processor.

8. The method of claim 1, wherein adjusting computer operation so as to reduce the temperature of the storage device comprises shutting down the computer.

9. The method of claim 1, wherein adjusting computer operation so as to reduce the temperature of the storage device comprises first increasing the speed of a fan contained in the computer and, if the storage device is later determined to still be too hot, reducing one or both of a clock speed of and a voltage provided to a processor contained in the computer and, is if the storage device is still later determined to be too hot, shutting down the computer.

10. The method of claim 1, further comprising data regarding temperature operating parameters of the storage device and using that data to determine whether the storage device is or is not too hot.

11. A method for cooling a storage device contained in a computer, the method comprising:
periodically measuring the temperature of the storage device with a temperature sensor provided in or on the storage device; and
periodically providing temperature data including the measured temperature and temperature operating parameters for the storage device to a basic input/output system (BIOS) so that the BIOS can control operation of the computer in an effort to cool the storage device.

12. The method of claim 1 1, wherein periodically measuring the temperature of the storage device comprises measuring the temperature of the storage device in response to commands received by a storage device driver stored in memory of the computer.

13. The method of claim 11, wherein periodically measuring the temperature of the storage device comprises measuring the temperature of the storage device using a thermal diode.

14. The method of claim 11, wherein periodically providing temperature data comprises providing the data to a storage device driver of the computer that provides the data to the BIOS.

15. The method of claim 1 1, wherein periodically providing temperature data comprises providing information regarding an ideal temperature operating range and a critical temperature to the BIOS.

16. A system for cooling a storage device in a computer, the system comprising:
means for measuring the temperature of the storage device, the means being directly associated with the storage device;
means for sending the measured temperature; and
means for adjusting operation of the computer in relation to the measured temperature.

17. The system of claim 16, wherein the means for measuring comprise a temperature sensor provided in or on the storage device.

18. The system of claim 17, wherein the means for measuring comprise a thermal diode.

19. The system of claim 17, wherein the means for sending the measured temperature comprise a controller of the storage device.

20. The system of claim 17, wherein the means for adjusting operation of the computer comprise a basic input/output system (BIOS).

21. The system of claim 20, wherein the BIOS is configured to increase the speed of a fan contained in the computer, reduce one or both of a clock speed of and a voltage provided to a processor contained in the computer, or shut down the computer if the storage device is too hot.

22. A system stored on a computer-readable medium, the system comprising:
logic configured to read a temperature of a storage device;
logic configured to command the logic configured to read a temperature to read that temperature; and
logic configured to receive the read temperature and to control operation of a computer relative to the read temperature.

23. The system of claim 22, wherein the logic configured to read a temperature is configured to reside in memory of the storage device.

24. The system of claim 22, wherein the logic configured to command the logic configured to read a temperature comprises a storage device driver.

25. The system of claim 22, wherein the logic configured to receive the read temperature and to control operation of a computer comprises a computer basic input/output system (BIOS).

26. A thermal monitor, comprising:
logic configured to command a storage device driver to periodically collect temperature data from a storage device; and
logic configured to provide the collected temperature data to a computer basic input/output system (BIOS) to enable the BIOS to control operation of the computer in a manner so as to cool the storage device.

27. A computer basic input/output system (BIOS), comprising:
logic configured to receive a temperature of a storage device measured by the storage device;
logic configured to compare the measured temperature with temperature operating parameters for the storage device; and
logic configured to control operation of a computer in which the storage device is provided in a manner that reduces the temperature of the storage device.

28. The BIOS of claim 27, wherein the logic configured to control operation of a computer comprises logic configured to increase the speed of a fan contained in the computer, reducing one or both of a clock speed of and a voltage provided to a processor contained in the computer, or shut down the computer if the storage device is too hot.
